(19) United States
(12) Patent Application Publication
(10) Pub. No.: US 2026/0131608 A1
(43) Pub. Date: May 14, 2026

(54) Vehicle towing hook lock

(71) Applicant: Dongguan Hongying Electrical Technology Co., Ltd., Dongguan City (CN)

(72) Inventor: Jiaying LIN, Dongguan City (CN)

(73) Assignee: Dongguan Hongying Electrical Technology Co., Ltd., Dongguan City (CN)

(21) Appl. No.: 19/183,075

(22) Filed: Apr. 18, 2025

(30) Foreign Application Priority Data
Nov. 11, 2024 (CN) 2024227323301

(51) Int. Cl. B60D 1/60; B60D 1/06

(52) U.S. Cl. CPC B60D 1/60; B60D 1/06

(57) ABSTRACT

A vehicle towing hook lock, comprises a first lock body assembly and a second lock body assembly, wherein the first lock body assembly and the second lock body assembly are suitable for telescoping and locking in a horizontal direction, so that a relative matching position of the first lock body assembly and the second lock body assembly at a vehicle towing hook could be changed in the horizontal direction; the first lock body assembly and the second lock body assembly are also suitable for telescoping and locking in a vertical direction, so that the relative matching position of the first lock body assembly and the second lock body assembly at the vehicle towing hook could also be changed in the vertical direction.

### INCORPORATION BY REFERENCE

This application claims priority to China Patent Application No 2024227323301, filed Nov. 11, 2024, the contents of which are hereby incorporated by reference in their entirety.

### TECHNICAL FIELD

The invention relates to the technical field of locks, in particular to a vehicle towing hook lock.

### BACKGROUND TECHNOLOGY

Trailer vehicles are a common type of vehicle, such as trailer caravans, trailer trucks, tractors, trailer working vehicles, and family cars/working vehicles equipped with rear towing devices, all of which are commonly used trailer vehicles.

The towing mechanisms are an important component of trailer vehicles, used to connect towing vehicles and trailers, allowing the towing vehicles to provide pulling power to the trailers. Typically, the towing mechanisms at end portions of the trailers are configured as tow hooks.

When the towing vehicles and the trailers of trailer vehicles are in a separated state, tow hooks on the trailers will be exposed outside the vehicle compartments, making it susceptible to being hooked by the towing mechanisms of other towing vehicles and towed away, which poses certain safety risks. Therefore, equipping the tow hooks with locks is one of the common safety precautions.

The Chinese invention patent publication with the publication number CN101193765A, titled “Coupling Lock,” discloses a typical vehicle tow hook lock, which comprises: a. a body configured to engage at least one surface of the coupler, with the body including a coupler engagement part; b. a coupler engagement member that is movable and configured to engage with the ball cavity of the coupler; and c. a fastening mechanism for fixing the position of the coupler engagement member relative to the body; wherein the fastening mechanism selectively fixes the position of the coupler engagement member relative to the body to secure the assembly to the coupler.

However, the vehicle tow hook locks in the prior art still have following technical issues:

The specifications of tow hooks (mainly including shapes and sizes) vary widely, making it difficult for a single type of vehicle tow hook lock to adapt to different specifications of tow hooks. If separate vehicle tow hook locks are developed to match various specifications of tow hooks, it will obviously increase the costs associated with research and development, production, storage, transportation, and sales in all stages.

In summary, how to provide a vehicle tow hook lock with good adaptability for different specifications of tow hooks has become one of the pressing issues that need to be addressed.

### SUMMARY OF THE INVENTION

The purpose of the present invention is to provide a vehicle tow hook lock that can adapt to multiple different specifications of tow hooks, offering improved adaptability.

To achieve the above objective, the present invention provides following technical solutions: a vehicle towing hook lock, comprises a first lock body assembly and a second lock body assembly, wherein the first lock body assembly is suitable for being attached to a surface of a vehicle towing hook, and the second lock body assembly is suitable for being connected into a hook body of the vehicle towing hook; the first lock body assembly and the second lock body assembly are suitable for telescoping and locking in a horizontal direction, so that a relative matching position of the first lock body assembly and the second lock body assembly at the vehicle towing hook could be changed in the horizontal direction; and the first lock body assembly and the second lock body assembly are also suitable for telescoping and locking in a vertical direction, so that the relative matching position of the first lock body assembly and the second lock body assembly at the vehicle towing hook could also be changed in the vertical direction.

In the above technical solutions, the first lock body assembly comprises a first towing hook matching component and an intermediate matching component, and the first towing hook matching component and the intermediate matching component are capable of being relatively telescopic and locked in the vertical direction; the second lock body assembly comprises a main body component and a second towing hook matching component, and the second towing hook matching component is fixedly mounted on the main body component; the intermediate matching component of the first lock body assembly and the main body component of the second lock body assembly are capable of being relatively telescopic and locked in the horizontal direction; and the first towing hook matching component of the first lock body assembly is suitable for being attached to the surface of the vehicle towing hook, and the second towing hook matching component of the second lock body assembly is suitable for being connected into the hook body of the vehicle towing hook.

In the above technical solutions, the first towing hook matching component of the first lock body assembly is provided with a first latch in the vertical direction; the intermediate matching component of the first lock body assembly is provided with insertion holes in the vertical direction; the first latch of the first towing hook matching component is capable of being inserting into the first insertion holes of the intermediate matching component, and the first latch of the first towing hook matching component is capable of sliding and being locked relative to the first insertion hole of the intermediate matching component.

In the above technical solutions, the first latch of the first towing hook matching component is provided with positioning holes along an extension direction thereof, thereby forming positioning hole groups; the intermediate matching component are provided with fixing holes penetrating into first insertion holes; and when the positioning holes in the positioning hole groups of the first latch are aligned with the fixing holes of the intermediate matching component, the first latch and the intermediate matching component will be penetrated and locked by a fixing member.

In the above technical solutions, the fixing holes of the intermediate matching component are configured as threaded holes or pin holes.

In the above technical solutions, the intermediate matching component of the first lock body assembly is provided with a second latch in the horizontal direction; the main body component of the second lock body assembly is provided with a second insertion hole in the horizontal direction; and the second latch of the intermediate matching component is capable of being inserted into the second insertion hole of the main body component, and the second latch of the intermediate matching component is capable of sliding and being locked relative to the second insertion hole of the main body component.

In the above technical solutions, the second latch of the intermediate matching component is provided with positioning toothed groups along an extension direction thereof; a lock core is embedded in the main body component of the second lock body assembly; the lock core comprises a lock tongue and a key transmission assembly capable of linking the lock tongue to move forward and backward in translation; the lock tongue of the lock core penetrates the second insertion hole, and when the key transmission assembly of the lock core is operated, the lock tongue is linked to move forward and backward to clamp/disengage any toothed groove in the positioning toothed group of the second latch.

In the above technical solutions, the lock tongue of the lock core comprises elastic reset capability; the key transmission assembly is provided with a dial wheel on an inner side of the lock core; when the key transmission assembly of the lock core is operated to put the key transmission assembly in a locked state, the dial wheel of the key transmission assembly does not apply force to the lock tongue, and the lock tongue of the lock core moves forward and clamps any toothed groove in the positioning toothed groups of the second latch; when the key transmission assembly of the lock core is operated to put the key transmission assembly in an unlocked state, the dial wheel of the key transmission assembly applies force to the lock tongue, so that the lock tongue of the lock core retreats to disengage from the positioning toothed groups of the second latch.

In the above technical solutions, the first towing hook matching component of the first lock body assembly comprises an inner side configured as an arc-shaped surface. In the above technical solutions, the second towing hook matching component of the second lock body assembly is configured as a ball head.

Compared with the prior art, beneficial effects of the present invention are as follows: the relative matching positions of the first lock body assembly and the second lock body assembly of the vehicle tow hook lock of the present invention at the vehicle tow hook can be changed in the horizontal direction and the vertical direction respectively, so as to adapt to a variety of relative matching positions in the horizontal direction and the vertical direction, have better versatility, and effectively adapt to a variety of tow hooks of different specifications, thereby saving costs in the development, manufacturing, maintenance and spare parts.

### BRIEF DESCRIPTION OF THE DRAWINGS

FIG. 1 is a three-dimensional view of the present invention.

FIG. 2 is an exploded view of the present invention.

FIG. 3 is a cross-sectional view of a second latch and a lock core of the present invention.

FIG. 4 is a structural view of the lock core in the present invention.

The markups in the drawings are indicated as follows:
1—first lock body assembly;
11—first towing hook matching component;
111—first latch;
112—positioning hole group;
12—intermediate matching component;
121—first insertion hole;
122—fixing hole;
123—second latch;
124—positioning toothed group;
2—second lock body assembly;
21—main body component;
211—second insertion hole;
22—lock core;
221—lock tongue;
222—key transmission assembly;
2221—dial wheel; and
23—second towing hook matching component.

### SPECIFIC EMBODIMENTS

The following will be combined with drawings in embodiments of the present invention to clearly and completely describe the technical solutions in the embodiments of the present invention. Obviously, the described embodiments are only some embodiments of the present invention, not all of the embodiments. Based on the embodiments of the present invention, all other embodiments obtained by ordinary technicians in this field without creative work are within the scope of protection of the present invention.

The present embodiment provides a vehicle tow hook lock, which can be used at a tow hook of a towed vehicle (such as a towed caravan, a towed truck, a tractor, a towed work vehicle, a family car/work vehicle with a rear towing device, etc.) to lock the tow hook to prevent the tow hook from being stolen.

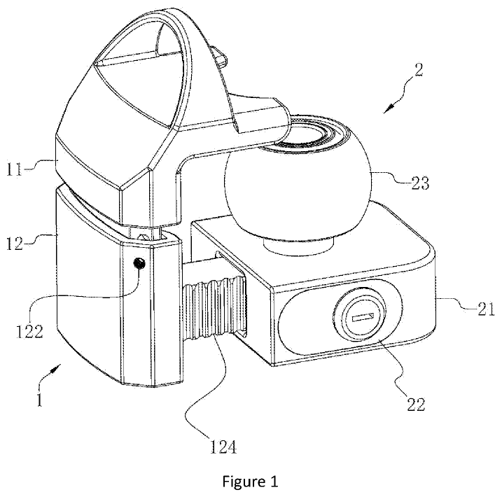

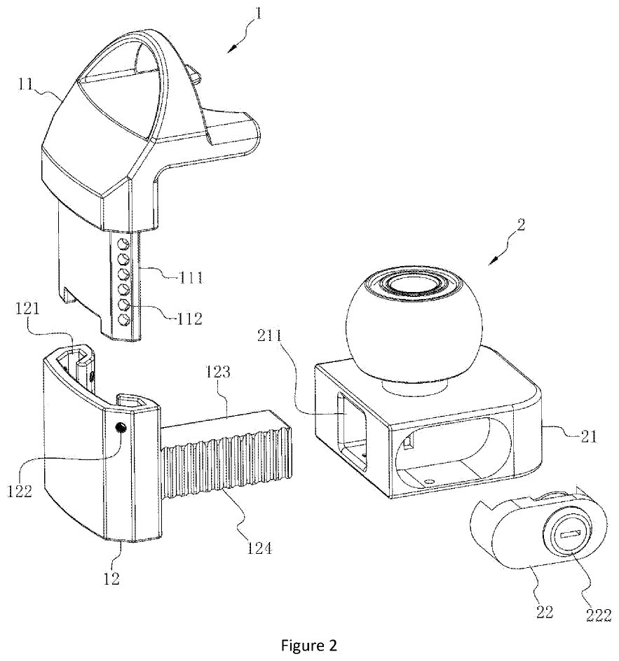

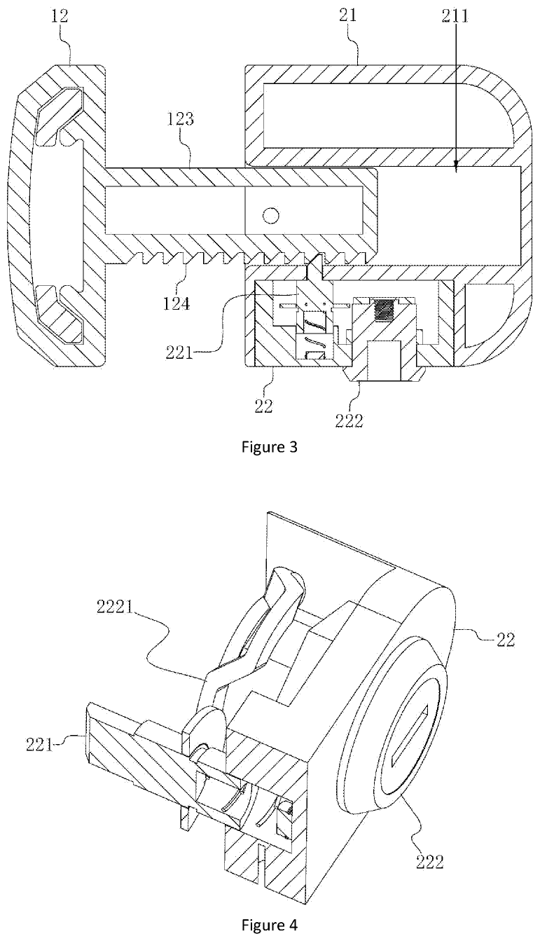

Please refer to FIGS. 1 to 4, the vehicle tow hook lock of the present embodiment comprises a first lock body assembly 1 and a second lock body assembly 2, wherein the first lock body assembly 1 is suitable for being attached to a surface of the vehicle tow hook, and the second lock body assembly 1 is suitable for being connected into a hook body of the vehicle tow hook.

In order to enable the vehicle towing hook lock to adapt to a variety of horizontal relative matching positions, the first lock body assembly 1 and the second lock body assembly 2 are suitable for extending and locking in a horizontal direction, so that relative matching positions of the first lock body assembly 1 and the second lock body assembly 2 on the towing vehicle can be changed in the horizontal direction.

In order to enable the vehicle towing hook lock to adapt to a variety of vertical relative matching positions, the first lock body assembly 1 and the second lock body assembly 2 are also suitable for telescoping and locking in a vertical direction, so that relative matching positions of the first lock body assembly 1 and the second lock body assembly 2 on the towing vehicle can also be changed in the vertical direction.

Specifically, the first lock body assembly 1 comprises a first towing hook matching component 11 and an intermediate matching component 12, wherein the first towing hook matching component 11 and the intermediate matching component 12 are both metal components, such as solid stainless steel, and the first towing hook matching component 11 and the intermediate matching component 12 can be relatively telescopic and locked in the vertical direction; the second lock body assembly 2 comprises a main body component 21 and a second towing hook matching component 23, the main body component 21 is a metal component, such as solid stainless steel, and the second towing hook matching component 23 is fixedly installed on the main body component 21; the intermediate matching component 12 of the first lock body assembly 1 and the main body component 21 of the second lock body assembly 2 can be relatively telescopic and locked in the horizontal direction; and the first towing hook matching component 11 of the first lock body assembly 1 is suitable for being attached to the surface of the vehicle towing hook, and the second towing hook matching component 23 of the second lock body assembly 2 is suitable for being connected into the hook body of the vehicle towing hook.

Specifically, the first towing hook matching component 11 of the first lock body assembly 1 is provided with a first latch 111 along the vertical direction. In fact, the first latch 111 is a pin-shaped structural feature integrally formed at a bottom portion of the first towing hook matching component 11; and the intermediate matching component 12 of the first lock body assembly 1 is provided with first insertion holes 121 along the vertical direction. In fact, the first insertion holes 121 are a long hole-shaped structural feature integrally formed at the intermediate matching component 12; the first latch 111 of the first towing hook matching component 11 can be inserted into the first insertion holes 121 of the intermediate matching component 12, and the first latch 111 of the first towing hook matching component 11 can slide and lock relative to the first insertion holes 121 of the intermediate matching component 12.

More specifically, the first latch 111 of the first towing hook matching component 11 is provided with a plurality of positioning holes along its extension direction, thereby forming positioning hole groups 112; fixing holes 122 penetrating into the first insertion holes 121 are provided at the intermediate matching component 12; after the positioning holes in the positioning hole groups 112 of the first latch 111 and the fixing holes 122 of the intermediate matching component 12 are aligned with each other, they can be penetrated and locked by a fixing member.

Further, the fixing holes 122 of the intermediate matching component 12 are configured as threaded holes, and accordingly, the fixing member is a screw.

Specifically, the intermediate matching component 12 of the first lock body assembly 1 is provided with a second latch 123 in the horizontal direction. In fact, the second latch 123 is a pin-shaped structural feature integrally formed on a side of the intermediate matching component 12; the main body component 21 of the second lock body assembly 2 is provided with a second insertion hole 211 in the horizontal direction. In fact, the second insertion hole 211 is a long hole-shaped structural feature integrally formed at the main body component 21; and the second latch 123 of the intermediate matching component 12 can be inserted into the second insertion hole 211 of the main body component 21, and the second latch 123 of the intermediate matching component 12 can slide and lock relative to the second insertion hole 211 of the main body component 21.

To be more specific, the second latch 123 of the intermediate matching component 12 is provided with positioning toothed groups 124 along its extension direction. In the present embodiment, the positioning toothed groups 124 are integrally formed on one side of the second latch 123. A lock core 22 is embedded in the main body component 21 of the second lock body assembly 2. The lock core 22 comprises a lock tongue 221 and a key transmission assembly 222 capable of driving the lock tongue 221 to move forward and backward in translation. The lock tongue 221 of the lock core 22 penetrates the second insertion hole 211. When the key transmission assembly 222 of the lock core 22 is operated, the lock tongue 221 can be driven to move forward and backward in translation to clamp/disengage any toothed groove in the positioning toothed groups 124 of the second latch 123.

Specifically, the lock tongue 221 of the lock core 22 comprises elastic reset capability. In the present embodiment, the lock tongue 221 is a self-reset elastic lock tongue 221 commonly used in the prior art, and the lock tongue 221 is provided with elastic reset capability through a spring inside the lock core 22; the key transmission assembly 222 is provided with a dial wheel 2221 on an inner side of the lock core 22, and the dial wheel 2221 comprises at least one protruding structure; when the key transmission assembly 222 of the lock core 22 is operated to make the key transmission assembly 222 in the locked state, the dial wheel 2221 of the key transmission assembly 222 does not apply force to the lock tongue 221 (the dial wheel 2221 is not provided with force to the lock tongue 221). When the key transmission assembly 222 of the lock core 22 is operated to put the key transmission assembly 222 in the unlocked state, the dial wheel 2221 of the key transmission assembly 222 applies force to the lock tongue 221 (the at least one protruding structure of the dial wheel 2221 contacts a paddle of the lock tongue 221), causing the lock tongue 221 of the lock core 22 to retreat (at this time, the spring of the lock tongue 221 is compressed) to disengage from the positioning toothed groups 124 of the second latch 123.

Specifically, the first towing hook matching component 11 of the first lock body assembly 1 comprises an inner side configured as an arc surface, so that the first towing hook matching component is suitable for being attached to the surface of the vehicle towing hook.

Specifically, the second towing hook matching component 23 of the second lock body assembly 2 is configured as a ball head. In the present embodiment, the second towing hook matching component 23 comprises a rubber-coated ball head with a metal frame, which is fixed to the main body component 21 by screws.

In the vehicle tow hook lock of the present embodiment, the second tow hook matching component 23 of the second lock body assembly 2 is configured as a ball head, which can be adapted to be connected into the hook body of the vehicle tow hook, and the inner side of the first tow hook matching component 11 of the first lock body assembly 1 is configured as an arc surface, which is adapted to be attached to the surface of the vehicle tow hook; the first latch 111 of the first tow hook matching component 11 is slid along the first insertion holes 121 of the intermediate matching component 12, and after reaching a suitable position, the positioning holes in the positioning hole groups 112 of the first latch 111 are aligned with the fixing holes 122 of the intermediate matching component 12, and a fixing member (i.e., screw) is sequentially passed through the fixing holes 122 of the intermediate matching component 12 and the corresponding positioning holes of the first latch 111, i.e. the relative position of the first tow hook matching component 11 and the intermediate matching component 12 can be locked, and the vertical matching position of the vehicle tow hook lock can be adjusted and locked; the second latch 123 of the intermediate matching component 12 is slid along the second insertion hole 211 of the main body component 21, and after reaching an appropriate position, the key transmission assembly 222 of the lock core 22 is operated to put the key transmission assembly 222 in a locked state, and the dial wheel 2221 of the key transmission assembly 222 does not apply force to the lock tongue 221, and the lock tongue 221 of the lock core 22 moves forward and clamps the corresponding toothed groove in the positioning toothed groups 124 of the second latch 123, so that the relative position of the intermediate matching component 12 and the main body component 21 can be locked, and the horizontal matching position of the vehicle tow hook lock can be adjusted and locked.

The vehicle tow hook lock of this embodiment, the relative matching positions of the first lock body assembly 1 and the second lock body assembly 2 at the vehicle tow hook can be changed in the horizontal direction and the vertical direction respectively, so as to adapt to a variety of relative matching positions in the horizontal direction and the vertical direction. The present invention has good versatility and can effectively adapt to a variety of tow hooks of different specifications, thereby saving costs in the development, manufacturing, maintenance and spare parts.

Although embodiments of the present invention have been shown and described, it will be appreciated by those skilled in the art that various changes, modifications, substitutions and variations may be made to the embodiments without departing from the principles and spirit of the present invention, and that the scope of the present invention is defined by the appended claims and their equivalents.

1. A vehicle towing hook lock, comprising a first lock body assembly and a second lock body assembly, wherein
the first lock body assembly is suitable for being attached to a surface of a vehicle towing hook, and the second lock body assembly is suitable for being connected into a hook body of the vehicle towing hook;
the first lock body assembly and the second lock body assembly are suitable for telescoping and locking in a horizontal direction, so that a relative matching position of the first lock body assembly and the second lock body assembly at the vehicle towing hook could be changed in the horizontal direction; and
the first lock body assembly and the second lock body assembly are also suitable for telescoping and locking in a vertical direction, so that the relative matching position of the first lock body assembly and the second lock body assembly at the vehicle towing hook could also be changed in the vertical direction.

2. The vehicle towing hook lock according to claim 1, wherein the first lock body assembly comprises a first towing hook matching component and an intermediate matching component, and the first towing hook matching component and the intermediate matching component are capable of being relatively telescopic and locked in the vertical direction;
the second lock body assembly comprises a main body component and a second towing hook matching component, and the second towing hook matching component is fixedly mounted on the main body component;
the intermediate matching component of the first lock body assembly and the main body component of the second lock body assembly are capable of being relatively telescopic and locked in the horizontal direction; and
the first towing hook matching component of the first lock body assembly is suitable for being attached to the surface of the vehicle towing hook, and the second towing hook matching component of the second lock body assembly is suitable for being connected into the hook body of the vehicle towing hook.

3. The vehicle towing hook lock according to claim 2, wherein the first towing hook matching component of the first lock body assembly is provided with a first latch in the vertical direction;
the intermediate matching component of the first lock body assembly is provided with insertion holes in the vertical direction;
the first latch of the first towing hook matching component is capable of being inserting into the first insertion holes of the intermediate matching component, and the first latch of the first towing hook matching component is capable of sliding and being locked relative to the first insertion hole of the intermediate matching component.

4. The vehicle towing hook lock according to claim 3, wherein the first latch of the first towing hook matching component is provided with positioning holes along an extension direction thereof, thereby forming positioning hole groups;
the intermediate matching component are provided with fixing holes penetrating into first insertion holes; and
when the positioning holes in the positioning hole groups of the first latch aligns with the fixing holes of the intermediate matching component, the first latch and the intermediate matching component could be penetrated and locked by a fixing member.

5. The vehicle towing hook lock according to claim 4, wherein the fixing holes of the intermediate matching component are configured as threaded holes or pin holes.

6. The vehicle towing hook lock according to claim 2, wherein the intermediate matching component of the first lock body assembly is provided with a second latch in the horizontal direction;
the main body component of the second lock body assembly is provided with a second insertion hole in the horizontal direction; and
the second latch of the intermediate matching component is capable of being inserted into the second insertion hole of the main body component, and the second latch of the intermediate matching component is capable of sliding and being locked relative to the second insertion hole of the main body component.

7. The vehicle towing hook lock according to claim 6, wherein the second latch of the intermediate matching component is provided with positioning toothed groups along an extension direction thereof;
a lock core is embedded in the main body component of the second lock body assembly;
the lock core comprises a lock tongue and a key transmission assembly capable of linking the lock tongue to move forward and backward in translation; and
the lock tongue of the lock core penetrates the second insertion hole, and when the key transmission assembly of the lock core is operated, the lock tongue is linked to move forward and backward in translation, so as to clamp or disengage any toothed groove in the positioning toothed groups of the second latch.

8. The vehicle towing hook lock according to claim 7, wherein the lock tongue of the lock core comprises elastic reset capability;
the key transmission assembly is provided with a dial wheel on an inner side of the lock core;
when the key transmission assembly of the lock core is operated to put the key transmission assembly in a locked state, the dial wheel of the key transmission assembly does not apply force to the lock tongue, and the lock tongue of the lock core moves forward and clamps any toothed groove in the positioning toothed groups of the second latch; and
when the key transmission assembly of the lock core is operated to put the key transmission assembly in an unlocked state, the dial wheel of the key transmission assembly applies force to the lock tongue, so that the lock tongue of the lock core retreats to disengage from the positioning toothed groups of the second latch.

9. The vehicle towing hook lock according to claim 2, wherein the first towing hook matching component of the first lock body assembly comprises an inner side configured as an arc-shaped surface.

10. The vehicle towing hook lock according to claim 2, wherein the second towing hook matching component of the second lock body assembly is configured as a ball head.

11. The vehicle towing hook lock according to claim 3, wherein the first towing hook matching component of the first lock body assembly comprises an inner side configured as an arc-shaped surface.

12. The vehicle towing hook lock according to claim 4, wherein the first towing hook matching component of the first lock body assembly comprises an inner side configured as an arc-shaped surface.

13. The vehicle towing hook lock according to claim 5, wherein the first towing hook matching component of the first lock body assembly comprises an inner side configured as an arc-shaped surface.

14. The vehicle towing hook lock according to claim 6, wherein the second towing hook matching component of the second lock body assembly is configured as a ball head.

15. The vehicle towing hook lock according to claim 7, wherein the second towing hook matching component of the second lock body assembly is configured as a ball head.

16. The vehicle towing hook lock according to claim 8, wherein the second towing hook matching component of the second lock body assembly is configured as a ball head.
